(19) United States
(12) Patent Application Publication
(10) Pub. No.: US 2025/0247724 A1
(43) Pub. Date: Jul. 31, 2025

(54) INTER-NETWORK INTERFERENCE CHARACTERIZATION

(71) Applicant: Charter Communications Operating, LLC, St. Louis, MO (US)

(72) Inventor: Abdulrauf Hafeez, Cary, NC (US)

(73) Assignee: Charter Communications Operating, LLC, St. Louis, MO (US)

(21) Appl. No.: 18/428,269

(22) Filed: Jan. 31, 2024

(51) Int. Cl. H04W 24/10; H04B 17/318; H04W 16/14

(52) U.S. Cl. CPC H04W 24/10; H04B 17/328; H04W 16/14

(57) ABSTRACT

A base station of a wireless network measures signal strengths of incoming measurement messages received by the base station from other base stations and decodes information contained in the incoming measurement messages. For each incoming measurement message, the base station reports information to its network back end, where the reported information includes the measured signal strength of the incoming measurement message and at least some of the decoded information contained in the incoming measurement message. The base station also transmits, to other base stations, outgoing measurement messages containing, for each incoming measurement message, the measured signal strength of the incoming measurement message and at least some of the decoded information contained in the incoming measurement message. In this way, inter-network interference can be characterized and avoided.

### BACKGROUND

### Field of the Disclosure

The present disclosure relates to wireless communication networks and, more specifically but not exclusively, to techniques for measuring interference across different wireless networks.

### Description of the Related Art

This section introduces aspects that may help facilitate a better understanding of the disclosure. Accordingly, the statements of this section are to be read in this light and are not to be understood as admissions about what is prior art or what is not prior art.

In a time- and frequency-division wireless communication network, two or more of the network's base stations operating within a geographical area at the same time in the same frequency band or even just in adjacent frequency bands may result in intra-network signal interference that inhibits the communications between those base stations and their wireless users (e.g., cell phones and the like). To protect its communications, such a wireless network assigns different time slots and/or different frequencies to its base stations such that transmissions from its base stations will not interfere with one another.

Inter-network interference may also exist between nearby base stations of different wireless networks that share a single wireless spectrum, such as the Citizens Broadband Radio Service (CBRS) spectrum. To address this problem, a conventional inter-network spectrum bandwidth controller, such as a Spectrum Access System (SAS) for CBRS networks, relies on propagation modeling to predict inter-network interference and assign different frequency bands to the different wireless networks to prevent such inter-network interference. Each wireless network then allocates different frequencies in its assigned frequency band(s) to its own base stations to avoid intra-network interference.

Conventional propagation models are generally conservative, resulting in inefficient sharing among different networks using the same spectrum. Spectrum sharing could be made more effective if actual inter-network interference measurements were available to the bandwidth controller.

U.S. Pat. No. 9,985,808, the teachings of which are incorporated herein by reference in their entirety, describes a technique for characterizing inter-network interference levels between the base stations of different wireless networks in which the different base stations are assigned different time slots in which to transmit measurement signals. When a particular base station transmits its measurement signal within its assigned time slot, the other base stations measure and report the received signal levels (e.g., RSSI/RSRP levels) to the bandwidth controller. Such coordination is often not possible between the base stations of different wireless networks that share a single wireless spectrum within the same geographical area.

### SUMMARY

Problems in the prior art are addressed in accordance with the principles of the present disclosure by a technique for characterizing inter-network interference levels between the base stations of two or more different wireless communication networks.

In at least one embodiment, the present disclosure is a first base station of a first wireless network having a first back end, the first base station comprising a memory and at least one processor, coupled to the memory and operative to cause the first base station to (i) measure signal strengths of incoming measurement messages received by the first base station from other base stations; (ii) decode information contained in the incoming measurement messages; (iii) for each incoming measurement message, report information to the first back end, the reported information comprising the measured signal strength of the incoming measurement message and at least some of the decoded information contained in the incoming measurement message; and (iv) transmit outgoing measurement messages containing, for each incoming measurement message, the measured signal strength of the incoming measurement message and at least some of the decoded information contained in the incoming measurement message.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a diagram showing two different wireless communication networks that operate within the same geographical area while sharing the same frequency spectrum, according to certain embodiments of the present disclosure;

FIG. 2 is a flow diagram of the processing independently performed by each base station in FIG. 1, according to certain embodiments;

FIG. 3 is a flow diagram of the processing performed by the spectrum controller in FIG. 1, according to certain embodiments; and

FIG. 4 is a simplified hardware block diagram of an example node that can be used to implement each base station of FIG. 1, according to certain embodiments.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

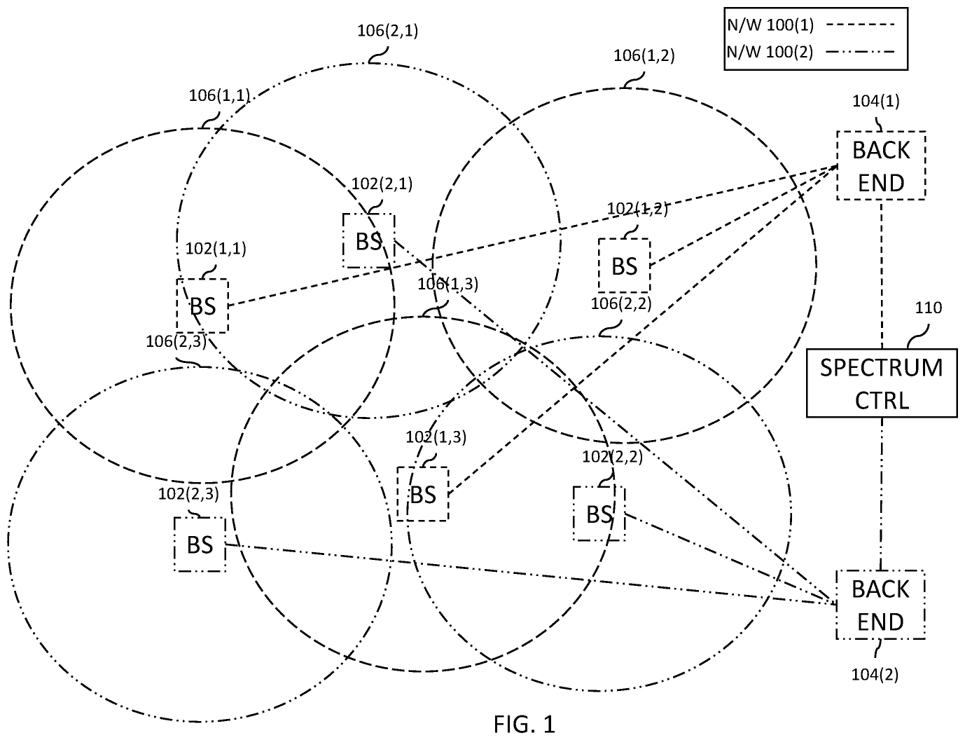

FIG. 1 is a simplified and idealized diagram showing two different wireless communication networks 100(1) and 100(2) of the present disclosure that operate within the same geographical area while sharing the same frequency spectrum. As shown in FIG. 1, each wireless network 100(i) has a number of different base stations 102(i,j) that communicate with user equipment (UEs) (e.g., cell phones) (not shown) of the network's customers as well as with the network's back end 104(i), which in turn communicates with an inter-network spectrum controller 110 that is responsible for allocating different frequencies within the shared spectrum to the base stations 102 of the two wireless networks 100.

In one possible implementation, the frequency spectrum is the CBRS spectrum, and the spectrum controller 110 is a SAS. Those skilled in the art will understand that other implementations may involve other frequency spectrums and other types of spectrum controllers, such as an automatic frequency controller (AFC) for the 6-GHz spectrum.

As shown in FIG. 1, the coverage area 106(1,j) of each base station 102(1,j) of the first wireless network 100(1) reaches the coverage areas 106(1,j) of some but not all of the base stations 102(2,j) of the second wireless network 100(2), and vice versa. For example, the coverage area 106(1,1) of first-network base station 102(1,1) overlaps with the respective coverage areas 106(2,1) and 106(2,3) of second-network base stations 102(2,1) and 102(2,3), but not the coverage area 106(2,2) of second-network base station 102(2,2), while the coverage area 106(2,2) of second-network base station 102(2,2) reaches the respective coverage areas 106(1,2) and 106(1,3) of first-network base stations 102(1,2) and 102(1,3), but not the coverage area 106(1,1) of first-network base station 102(1,1).

As such, if first-network base station 102(1,1) were to transmit at the same time using the same frequency as second-network base station 102(2,1), the resulting signal interference may prevent those two base stations 102 from successfully communicating with their respective UEs that are located within the coverage areas 106 of both base stations 102. However, first-network base station 102(1,1) and second-network base station 102(2,2) should be able to transmit at the same time using the same frequency without generating any interference that would prevent those two base stations from successfully communicating with their respective UEs since there is no overlap between the coverage areas 106(1,1) and 106(2,2) for those two base stations.

In order for the spectrum controller 110 to be able to assign specific frequencies to specific base stations 102 in a way that avoids or at least reduces the likelihood of interference, it is important for the spectrum controller 110 to have accurate information about both intra-network interference (i.e., interference between base stations 102 of the same network) and inter-network interference (i.e., interference between base stations 102 of different networks).

According to certain embodiments of the disclosure, the two networks 100(1) and 100(2) of FIG. 1 agree to participate in an inter-network interference characterization (INIC) procedure that is performed on a regular basis, e.g., for a relatively brief duration during low network traffic, such as every day at 2 am. According to certain implementations of the INIC procedure, each base station 102 transmits (i.e., broadcasts) wireless outgoing measurement messages at particular time periods (e.g., time slots in a measurement frame) during the duration of an instance of the INIC procedure. The number of time slots in a measurement frame may be determined by the maximum number of base stations expected to be deployed in the geographic area. The duration of the time slots should be designed to accommodate signal propagation delays from one base station to another within the base station's coverage area. The time slots should include a measurement gap long enough to allow a base station to detect an incoming measurement message transmitted in one time slot and then transmit its own outgoing measurement message in the next time slot, if appropriate. The measurement messages should be coded with enough redundancy to allow for robust detection and decoding by other base stations.

When a base station 102 is not sending its own outgoing measurement messages, it is listening for and measuring the received signal strength (RSS), such as received signal strength indicator (RSSI) level or reference signal received power (RSRP) level, of incoming measurement messages transmitted by other base stations 102, which RSS levels are forwarded by the base station 102 to its back end 104 along with other information described further below.

Each back end 104 collects the information (including the RSS levels) received from its base stations 102 and reports at least some of that information to the spectrum controller 110, which processes that information to determine which frequencies of the shared spectrum should be assigned to which base stations 102 of the two networks 100 in a way that avoids both inter-network interference and intra-network interference between the base stations 102. The spectrum controller 110 forwards the respective frequency assignments to the two back ends 104, which forward those assignments to their own base stations 102.

Depending on the particular implementation, the signal frequency of the measurement messages may be a specific frequency reserved for the INIC procedure.

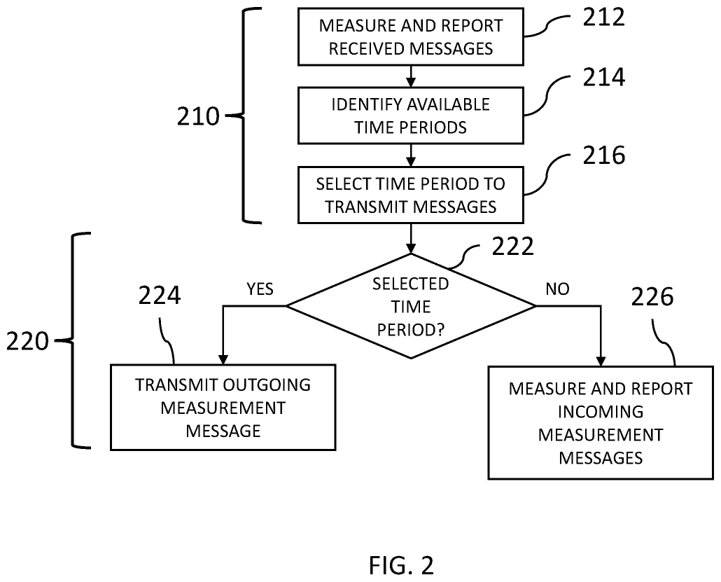

FIG. 2 is a flow diagram of the processing independently performed by each base station 102 in FIG. 1. In step 212, during an initial phase 210 corresponding to one or more instances of the INIC procedure immediately following the deployment of a new base station 102 in a network 100, the new base station 102 only listens for incoming measurement messages received from other base stations, measures the RSS levels of those incoming measurement messages, and reports the measured RSS levels along with other information decoded from the incoming measurement messages to its back end 104. During this initial phase 210, the new base station 102 does not transmit its own outgoing measurement messages.

Instead, during step 214, the new base station 102 identifies time periods during which the measured RSS levels at the new base station 102 are below a specified threshold level. The new base station 102 determines that these are time periods that are available for the new base station 102 to broadcast its own outgoing measurement messages and, in step 216, the new base station 102 selects one of those available time periods for its own transmissions of outgoing measurement messages using some specified selection algorithm, such as (without limitation), a first-available-period selection, a least-energy-period selection, or a random selection.

When the very first base station 102 gets deployed in a particular geographic area, there will be no measurement messages, and the first base station will determine that all time periods are available for its outgoing measurement messages. After a specific time period is selected for that first base station, the first base station will transmit outgoing measurement messages at that time period during each instance of the INIC procedure.

When the very second base station 102 gets deployed in that same geographic area, whether that second base station is part of the same wireless network or a different wireless network from the first base station, the second base station will receive the incoming measurement messages transmitted by the first base station, and the second base station will determine that all but one time period are available for its outgoing measurement messages. After a specific time period is selected for that second base station, the second base station will transmit outgoing measurement messages at that time period during each instance of the INIC procedure. And so on, as each new base station 102 is deployed in the same geographic area.

In alternative implementations, the INIC procedure may be initiated with a particular network provider (e.g., the network provider of wireless network 100(1)) assigning time periods to its own base stations 102 for transmitting their outgoing measurement messages, with the base stations 102 of other wireless network 100(2) and any base stations 102 subsequently deployed in the first wireless network 100(1) implementing the processing of FIG. 2.

Note that a new base station may end up selecting a time period that is already being used by another, previously deployed base station, where the RSS levels measured by the new base station for the measurement messages transmitted from that other base station are below the specified threshold level such that those measurement messages cannot be successfully decoded by the new base station 102. For example, referring again to FIG. 1, new base station 102(2,3) may end up selecting the same time period to transmit its own outgoing measurement messages that existing base station 102(1,2) already uses for its outgoing measurement messages because the new base station 102(2,3) cannot decode measurement messages transmitted by the existing base station 102(1,2).

Although the two base stations 102(1,2) and 102(2,3) might not directly interfere with one another, it is possible that their outgoing measurement messages may collide at another base station, e.g., base station 102(1,3) in the mutual coverage area of base stations 102(1,2) and 102(2,3). If base station 102(1,3) is the only base station in the mutual coverage area of base stations 102(1,2) and 102(2,3), then base station 102(1,3) may indicate in its outgoing measurement message information that it did not decode any measurement message in the time slot. Upon reading this information, base stations 102(1,2) and 102(2,3) would interpret that there is a problem, e.g. collision, in the time slot chosen to transmit their message. In this case, they would initiate a change of time slot which can be done randomly from the available time slots to each of them. Another way base stations 102(1,2) and 102(2,3) could figure out that there is a collision is through reading incoming measurement messages of other base stations in the area.

In alternative implementations, the base station's back end 104 is responsible for identifying the available time periods and selecting the specific time period for the new base station 102 to transmit its own outgoing measurement messages. In this way, the occurrence of two different, mutually interfering base stations 102 of the same network 100 having the same selected time period may be avoided. In still other implementations, the spectrum controller 110 is responsible for identifying the available time periods and selecting the specific time period for the new base station 102 to transmit its own outgoing measurement messages. In this way, the occurrence of two different, mutually interfering base stations of either the same network or different networks having the same selected time period may be avoided.

Following the initial phase 210, the no-longer-new base station 102 performs normal processing 220. In particular, during each instance of the INIC procedure, in step 222, the base station 102 determines whether the current time period is the base station's selected time period. If so, then, in step 224, the base station 102 transmits its own outgoing measurement message; otherwise, in step 226, when it is not transmitting its own outgoing measurement message, the base station 102 listens for, measures, decodes, and reports, to its back end 104, incoming measurement messages received from other base stations.

Depending on the particular implementation, each outgoing measurement message transmitted by a given base station 102 may contain some or all of the following information:
Identification (ID) of the given base station, sector, and/or beam depending on whether the given base station has an omnidirectional, sectored, and/or beamforming antenna;
ID of the given base station's network;
Location (e.g., latitude and longitude) of the given base station;
Transmit power level or equivalent isotropic radiated power (EIRP) of the given base station's outgoing measurement messages; and
Information corresponding to each incoming measurement message received by the given base station from another base station during the current instance of the INIC procedure including one or more of:
   Received signal level, such as RSSI or RSRP, of the incoming measurement message as measured by the given base station;
   Time period of the incoming measurement message;
   The base station, sector, and/or beam ID for the other base station contained in the incoming measurement message and decoded by the given base station;
   ID of the other base station's network contained in the incoming measurement message and decoded by the given base station;
   Location of the other base station contained in the incoming measurement message and decoded by the given base station; and
   Transmit power level or EIRP of the other base station's outgoing measurement messages contained in the incoming measurement message and decoded by the given base station.

In some implementations, an incoming measurement message received by the given base station from another base station may also include similar information corresponding to other incoming measurement messages received by that other base station that were transmitted by still other base stations, and that similar information may be included in the outgoing measurement messages transmitted by the given base station.

Depending on the particular implementation, each base station 102 forwards, to its back end 104, some or all of the aforementioned information corresponding to the incoming measurement messages that the base station 102 receives from other base stations. Likewise, each back end 104 forwards, to the spectrum controller 110, some or all of the information that the back end 104 receives from its base stations 102. Note that, in some implementations, some of the information, such base station locations, may be obfuscated to protect private or confidential network information.

Note that each base station 102 may receive incoming measurement messages from one or more other base stations in its own network as well as incoming measurement messages from one or more base stations in another network. Thus, the information collected by the base stations 102 and forwarded to the back ends 104 and eventually to the spectrum controller 110 may include information corresponding to incoming intra-network measurement messages as well as information corresponding to incoming inter-network measurement messages. Based on the locations of the base stations and the identities of their respective networks, the collected information can be properly interpreted.

In particular, each base station 102 will be able to identify which incoming measurement messages are received from other base stations in its network and which incoming measurement messages are received from other base stations in another network. Similarly, each back end 104 and the spectrum controller 110 will be able to identify which RSS levels correspond to base stations in the same network and which RSS levels correspond to base stations in different networks.

The collected information can be used to (i) identify which time periods are available for each base station to transmit its own outgoing measurement messages and then (ii) select one of those time periods for each base station that avoids interfering with outgoing measurement messages transmitted by other base stations. As described above, depending on the implementation, this processing may be independently performed by each base station 102 for itself, at each back end 104 for all of its base stations 102, and/or at the spectrum controller 110 for all of the base stations 102 for all of the networks 100.

In addition, the collected information can be used by the spectrum controller 110 to assign specific frequencies to the different base stations 102 for their respective communications with their UEs such that interference between different base stations of either the same network or different networks is avoided or at least limited.

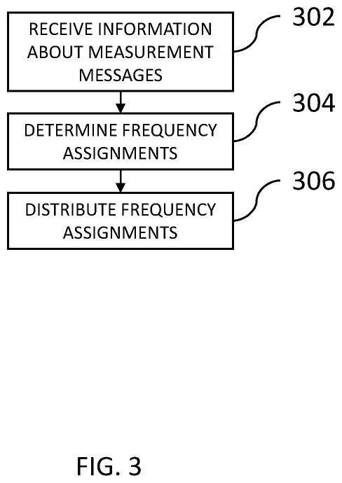

FIG. 3 is a flow diagram of the processing performed by the spectrum controller 110 in FIG. 1. In step 302, for the recent instance of the INIC procedure, the spectrum controller 110 receives information about the measurement messages from the back ends 104(1) and 104(2). In step 304, the spectrum controller 110 processes that information to determine frequency assignments for the base stations 102 of the two networks 100(1) and 100(2). For example, if the networks or some of their base stations are determined to interfere with each other resulting in a loss of performance for one network or both above a certain minimum requirement, then the spectrum controller 110 would provide the networks frequency assignments such as to avoid interference. If the networks are determined to not interfere with each other, then the spectrum controller 110 may provide them the identical frequency assignments to conserve and efficiently utilize spectrum resources. The networks or their base stations may request certain frequency assignments of their preference and the spectrum controller 110 may accept or deny them depending on its interference assessment. In step 306, the spectrum controller 110 distributes the respective frequency assignments to the two back ends 104(1) and 104(2), which assign those respective frequency assignments to their base stations 102. Note that, in such embodiments, the (independent) spectrum controller 110 is responsible for assigning frequencies, and there is no direct coordination between the different network providers.

In some alternative embodiments of the disclosure, the back ends 104(1) and 104(2) share information about the measurement messages directly with one another such that the spectrum controller 110 is optional. In those embodiments, the network operators coordinate their frequency assignments to avoid inter-network interference.

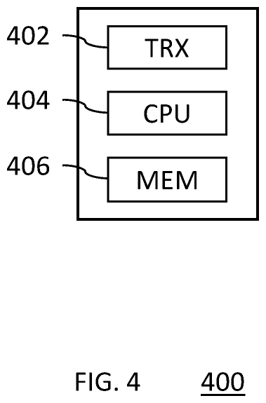

FIG. 4 is a simplified hardware block diagram of an example node 400 that can be used to implement each base station 102 of FIG. 1. As shown in FIG. 4, the node 400 includes (i) communication hardware (e.g., wireless, wireline, and/or optical transceivers (TRX)) 402 that supports communications with other nodes, (ii) a processor (e.g., CPU microprocessor) 404 that controls the operations of the node 400, and (iii) a memory (e.g., RAM, ROM) 406 that stores code executed by the processor 404 and/or data generated and/or received by the node 400. Note that the back ends 104 and the spectrum controller 110 of FIG. 1 may each be implemented using analogous configurations of communication hardware, processors, and memories.

Although the disclosure has been described in the context of a situation in which two different wireless networks 100(1) and 100(2) have base stations 102 in the same geographic area, those skilled in the art will understand that the disclosure covers situations having more than two such wireless networks.

In certain embodiments, the present disclosure is a first base station of a first wireless network having a first back end, the first base station comprising a memory and at least one processor, coupled to the memory and operative to cause the first base station to (i) measure signal strengths of incoming measurement messages received by the first base station from other base stations; (ii) decode information contained in the incoming measurement messages; (iii) for each incoming measurement message, report information to the first back end, the reported information comprising the measured signal strength of the incoming measurement message and at least some of the decoded information contained in the incoming measurement message; and (iv) transmit outgoing measurement messages containing, for each incoming measurement message, the measured signal strength of the incoming measurement message and at least some of the decoded information contained in the incoming measurement message.

In at least some of the above embodiments, the first base station is operative to identify time periods that are available for the first base station to transmit the outgoing measurement messages and select a specific time period from the available time periods for the first base station to transmit the outgoing measurement messages.

In at least some of the above embodiments, the first base station is operative to identify the available time periods based on measured signal strengths below a specified threshold level.

In at least some of the above embodiments, for each incoming measurement message received from an other base station, the decoded information comprises one or more of identification of the other base station; identification of the other base station's network; location of the other base station; and transmit power level of the other base station's outgoing measurement messages.

In at least some of the above embodiments, for each incoming measurement message received by the first base station from an other base station, the decoded information further comprises information decoded by the other base station from incoming measurement messages received by the other base station.

In at least some of the above embodiments, for each incoming measurement message received from an other base station, the decoded information excludes location of the other base station.

In at least some of the above embodiments, each outgoing measurement message transmitted by the first base station comprises one or more of identification of the first base station; identification of the first base station's network; location of the first base station; and transmit power level of the first base station's outgoing measurement messages.

In at least some of the above embodiments, each outgoing measurement message transmitted by the first base station further comprises (i) the measured signal strengths of the incoming measurement messages received by the first base station from other base stations, (ii) time periods of the incoming measurement messages, and (iii) information decoded by the first base station from the incoming measurement messages.

In at least some of the above embodiments, for each outgoing measurement message transmitted by the first base station, the decoded information excludes location of the first base station.

In at least some of the above embodiments, for each incoming measurement message received by the first base station from an other base station, the information reported to the first back end comprises one or more of the measured signal strength of the incoming measurement message; time period of the incoming measurement message; identification of the other base station; identification of the other base station's network; location of the other base station; and transmit power level of the other base station's outgoing measurement messages.

In at least some of the above embodiments, for each incoming measurement message received by the first base station from an other base station, the information reported to the first back end further comprises information decoded by the other base station from incoming measurement messages received by the other base station.

In at least some of the above embodiments, for each incoming measurement message received by the first base station from an other base station, the information reported to the first back end excludes the location of the other base station.

In at least some of the above embodiments, at least one of the other base stations is part of a different wireless network sharing a spectrum with the first wireless network.

In at least some of the above embodiments, the first wireless network is a Citizens Broadband Radio Service (CBRS) network.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A first base station of a first wireless network having a first back end, the first base station comprising a memory and at least one processor, coupled to the memory and operative to cause the first base station to:
measure signal strengths of incoming measurement messages received by the first base station from other base stations;
decode information contained in the incoming measurement messages;
for each incoming measurement message, report information to the first back end, the reported information comprising the measured signal strength of the incoming measurement message and at least some of the decoded information contained in the incoming measurement message; and
transmit outgoing measurement messages containing, for each incoming measurement message, the measured signal strength of the incoming measurement message and at least some of the decoded information contained in the incoming measurement message.

2. The first base station of claim 1, wherein the first base station is operative to:
identify time periods that are available for the first base station to transmit the outgoing measurement messages; and
select a specific time period from the available time periods for the first base station to transmit the outgoing measurement messages.

3. The first base station of claim 2, wherein the first base station is operative to identify the available time periods based on measured signal strengths below a specified threshold level.

4. The first base station of claim 1, wherein, for each incoming measurement message received from an other base station, the decoded information comprises one or more of:
identification of the other base station;
identification of the other base station's network;
location of the other base station; and
transmit power level of the other base station's outgoing measurement messages.

5. The first base station of claim 4, wherein, for each incoming measurement message received by the first base station from an other base station, the decoded information further comprises information decoded by the other base station from incoming measurement messages received by the other base station.

6. The first base station of claim 4, wherein, for each incoming measurement message received from an other base station, the decoded information excludes location of the other base station.

7. The first base station of claim 1, wherein each outgoing measurement message transmitted by the first base station comprises one or more of:
identification of the first base station;
identification of the first base station's network;
location of the first base station; and
transmit power level of the first base station's outgoing measurement messages.

8. The first base station of claim 7, wherein each outgoing measurement message transmitted by the first base station further comprises (i) the measured signal strengths of the incoming measurement messages received by the first base station from other base stations, (ii) time periods of the incoming measurement messages, and (iii) information decoded by the first base station from the incoming measurement messages.

9. The first base station of claim 7, wherein, for each outgoing measurement message transmitted by the first base station, the decoded information excludes location of the first base station.

10. The first base station of claim 1, wherein, for each incoming measurement message received by the first base station from an other base station, the information reported to the first back end comprises one or more of:
the measured signal strength of the incoming measurement message;
time period of the incoming measurement message;
identification of the other base station;
identification of the other base station's network;
location of the other base station; and
transmit power level of the other base station's outgoing measurement messages.

11. The first base station of claim 10, wherein, for each incoming measurement message received by the first base station from an other base station, the information reported to the first back end further comprises information decoded by the other base station from incoming measurement messages received by the other base station.

12. The first base station of claim 10, wherein, for each incoming measurement message received by the first base station from an other base station, the information reported to the first back end excludes the location of the other base station.

13. The first base station of claim 1, wherein at least one of the other base stations is part of a different wireless network sharing a spectrum with the first wireless network.

14. The first base station of claim 1, wherein the first wireless network is a Citizens Broadband Radio Service (CBRS) network.

15. A method for a first base station for a first wireless network having a first back end, the method comprising the first base station:
measuring signal strengths of incoming measurement messages received by the first base station from other base stations;
decoding information contained in the incoming measurement messages;
for each incoming measurement message, reporting information to the first back end, the reported information comprising the measured signal strength of the incoming measurement message and at least some of the decoded information contained in the incoming measurement message; and
transmitting outgoing measurement messages containing, for each incoming measurement message, the measured signal strength of the incoming measurement message and at least some of the decoded information contained in the incoming measurement message.

16. The method of claim 15, further comprising the first base station:
identifying time periods that are available for the first base station to transmit the outgoing measurement messages; and
selecting a specific time period from the available time periods for the first base station to transmit the outgoing measurement messages.

17. The method of claim 16, wherein the first base station identifies the available time periods based on measured signal strengths below a specified threshold level.

18. The method of claim 15, wherein, for each incoming measurement message received from an other base station, the decoded information comprises one or more of:
identification of the other base station;
identification of the other base station's network;
location of the other base station; and
transmit power level of the other base station's outgoing measurement messages.

19. The method of claim 18, wherein, for each incoming measurement message received by the first base station from an other base station, the decoded information further comprises information decoded by the other base station from incoming measurement messages received by the other base station.

20. The method of claim 18, wherein, for each incoming measurement message received from an other base station, the decoded information excludes location of the other base station.

21. The method of claim 15, wherein each outgoing measurement message transmitted by the first base station comprises one or more of:
identification of the first base station;
identification of the first base station's network;
location of the first base station; and
transmit power level of the first base station's outgoing measurement messages.

22. The method of claim 21, wherein each outgoing measurement message transmitted by the first base station further comprises (i) the measured signal strengths of the incoming measurement messages received by the first base station from other base stations, (ii) time periods of the incoming measurement messages, and (iii) information decoded by the first base station from the incoming measurement messages.

23. The method of claim 21, wherein, for each outgoing measurement message transmitted by the first base station, the decoded information excludes location of the first base station.

24. The method of claim 15, wherein, for each incoming measurement message received by the first base station from an other base station, the information reported to the first back end comprises one or more of:
the measured signal strength of the incoming measurement message;
time period of the incoming measurement message;
identification of the other base station;
identification of the other base station's network;
location of the other base station; and
transmit power level of the other base station's outgoing measurement messages.

25. The method of claim 24, wherein, for each incoming measurement message received by the first base station from an other base station, the information reported to the first back end further comprises information decoded by the other base station from incoming measurement messages received by the other base station.

26. The method of claim 24, wherein, for each incoming measurement message received by the first base station from an other base station, the information reported to the first back end excludes the location of the other base station.

27. The method of claim 15, wherein at least one of the other base stations is part of a different wireless network sharing a spectrum with the first wireless network.

28. The method of claim 15, wherein the first wireless network is a Citizens Broadband Radio Service (CBRS) network.
